(19) United States
(12) Patent Application Publication
(10) Pub. No.: US 2006/0043133 A1
(43) Pub. Date: Mar. 2, 2006

(54) Bicycle carrier to attach a bicycle to a vehicle

(76) Inventor: Nathaniel C. Bair, Ann Arbor, MI (US)

Correspondence Address: SCHOX PLC, 209 N. MAIN STREET #200, ANN ARBOR, MI, 48104, US

(21) Appl. No.: 11/212,538

(22) Filed: Aug. 26, 2005

Related U.S. Application Data
(60) Provisional application No. 60/605,268, filed on Aug. 30, 2004.

(51) Int. Cl. B60R 9/00

(52) U.S. Cl. 224/519; 224/405; 224/521; 224/924; 224/322

(57) ABSTRACT

The invention includes a bicycle carrier, and a method, to attach a bicycle with a seat tube to a vehicle. The bicycle carrier preferably includes a post adapted to be temporarily inserted into the seat tube, and a fastener coupled to the post and adapted to attach to the vehicle. The method preferably includes the following steps: a) providing a bicycle carrier having a post and a fastener; b) attaching the fastener of the bicycle carrier to the vehicle; c) removing a seat post of the bicycle; d) inverting the bicycle; and e) inserting the post into the seat tube of the bicycle.

### CROSS-REFERENCE TO RELATED APPLICATIONS

This application claims the benefit of U.S. Provisional Application No. 60/605,268 (filed 30 Aug. 2004 and entitled “Vehicle Hitch Mounted Inverted Bicycle Carrier”), which is incorporated in its entirety by this reference.

### TECHNICAL FIELD

This invention relates generally to the bicycle carrier field, and more specifically to an improved device to attach a bicycle with a seat tube to a vehicle.

### BRIEF DESCRIPTION OF THE FIGURES

FIGS. 1 and 2 are perspective views of the first preferred embodiment of the invention.

FIGS. 3, 4A, 4B, and 5 are alternative variations of the first preferred embodiment of the invention.

FIG. 6 is a perspective view of the second preferred embodiment of the invention.

FIG. 7 is a perspective view of the third preferred embodiment of the invention.

FIGS. 8A, 8B, and 8C are side views of the preferred method of the invention.

### DESCRIPTION OF THE PREFERRED EMBODIMENTS

The following description of the three preferred embodiments of the invention is not intended to limit the invention to these preferred embodiments, but rather to enable any person skilled in the art to make and use this invention.

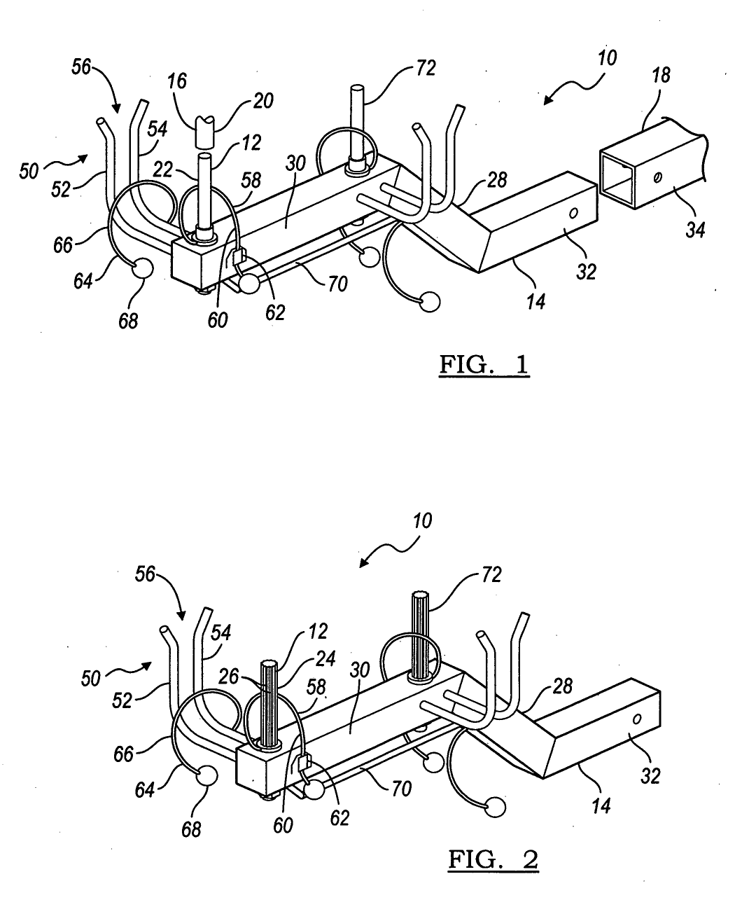

As shown in FIG. 1, the bicycle carrier 1o of the preferred embodiments includes a post 12 and a fastener 14 coupled to the post 12 and adapted to attach the bicycle carrier 10 to a vehicle. The bicycle carrier 10 is preferably designed to attach a bicycle 16 with a seat tube 20 to a vehicle 18. The bicycle carrier 10 may, however, be used to attach a unicycle or any suitable cycle with a seat tube 20 to a vehicle or any suitable temporary storage.

The post 12 of each of the preferred embodiments functions to be temporarily inserted into the seat tube 20 of an inverted bicycle 16. Since conventional seat tubes have a bore that is cylindrically shaped, the post 12 is preferably a rod that is cylindrically shaped. The post 12 may, however, have any suitable shape. In a first variation, the post 12 is preferably made of a rigid material, such as a metal, and is preferably covered by a protective layer 22. The protective layer 22, which functions to reduce damage to the seat tube 20, is preferably made of a rubber material, but may be made of a plastic material or any other suitable material. In a second variation, as shown in FIG. 2, the post 12 includes a flexible portion 24. The flexible portion 24 functions to conform to the seat tube, regardless of the inner diameter of the seat tube 20. The flexible portion 24 is preferably formed with several projections 26 that extend in a radial direction from the central axis of the post 12. The post 12 of the second variation may include a rigid portion.

In the preferred embodiments, as shown in FIG. 1, the bicycle carrier 10 also includes a frame 28. The frame 28 functions to connect and orient the post 12 and the fastener 14. The frame 28 is preferably made of a rigid material, such as metal, but may be made of any suitable material.

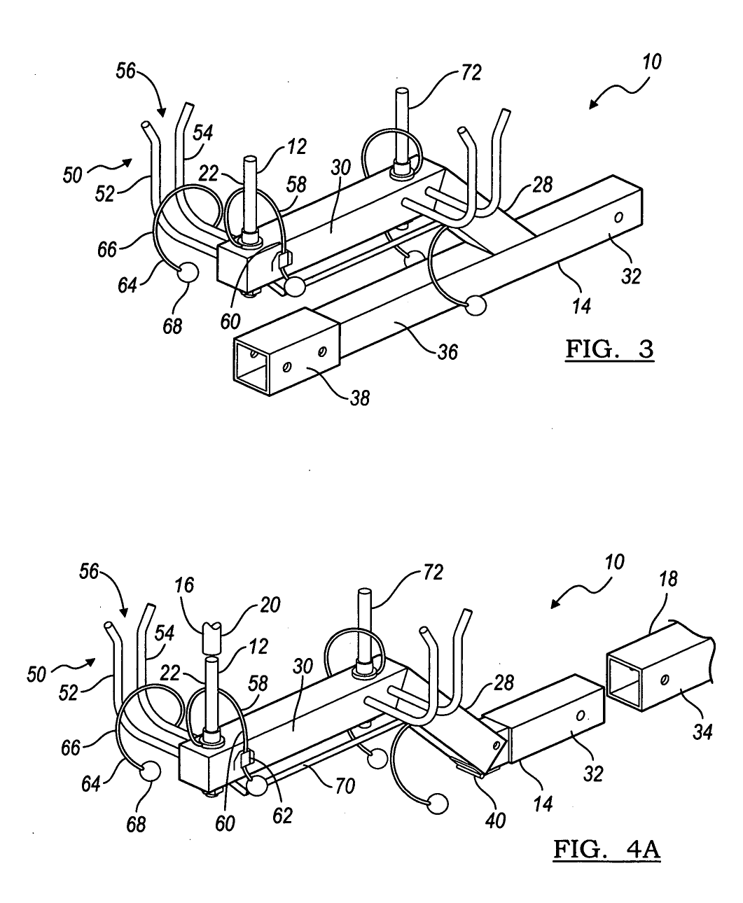

In the first preferred embodiment, the frame 28 preferably includes a first arm 30 that attaches to the post 12 and a second arm 32 that attaches to the fastener 14. The fastener 14 of this embodiment functions to attach the bicycle carrier 10 to a hitch 34 of a vehicle 18 and, as such, is preferably sized and shaped to mate with a receiver of a hitch 34. The fastener 14 is preferably integrally formed with the frame 28, but may be separatly formed and fixed to the frame 28 with any suitable method, such as welding. The frame 28 preferably includes a zig-zag shape that allows the fastener 14 to mate with the hitch 34 closer to the bottom of the vehicle 18 and allows the post 12 to be inserted into the seat tube 20 closer to waist height of a typical user. In a first alternative variation, as shown in FIG. 3, the frame 28 also includes a third arm 36. The bicycle carrier 10 of this variation of the first embodiment also includes an additional receiver 38 for a hitch that allows a user to selectively attach an additional trailer or hitch 34 for additional hauling. In a second alternative variation, as shown in FIG. 4A, the frame 28 also includes a hinge mechanism 40. The hinge mechanism 40 functions to allow a user to pivot the bicycle carrier (and the bicycle) out of the way, and to access a portion of the vehicle (such as a luggage compartment). The hinge mechanism 40 operates between a locked position and an unlocked position, shown in FIG. 4B. In a third alternative variation, as shown in FIG. 5, the frame 28 defines a bore 42. The bore 42 is sized to accept a section of the post 12. The bicycle carrier 10 of this variation also includes a securing mechanism 44 that attaches to the end of the post 12 thereby securing the post 12 to the frame 28. The securing mechanism 44 is preferably a threaded nut, but may alternatively be any suitable device able to secure the post 12 to the frame 28. With this third alternative variation of the first preferred embodiment, the bicycle carrier 10 is able to be displayed and shipped to the user in a compact package and the user is able to assemble the bicycle carrier 10 with standard tools found in the typical home.

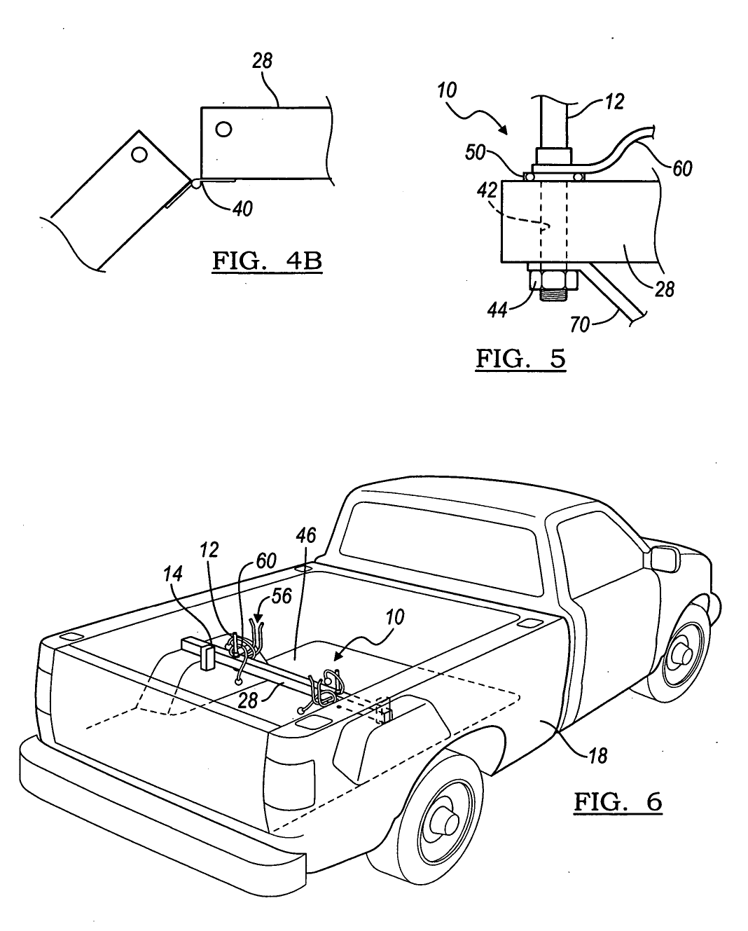

In the second preferred embodiment, as shown in FIG. 6, the frame 28 preferably extends the substantial width of a bed 46 of the vehicle 18, such as a truck. The fastener 14 of this embodiment functions to attach the bicycle carrier 10 to the bed 46 of the vehicle 18. The fastener 14 preferably includes bolts, but may include any suitable device or method, including magnets, that attach the bicycle carrier 10 to the bed 46 of the vehicle 18.

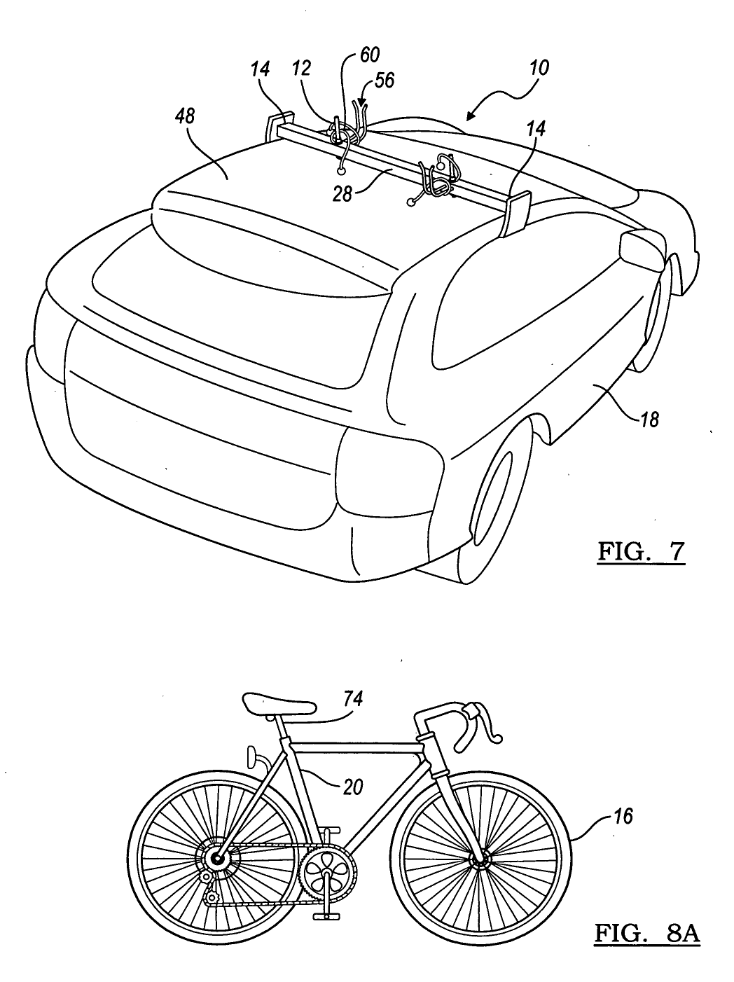

In the third preferred embodiment, as shown in FIG. 7, the frame 28 preferably extends the substantial width of a roof 48 of the vehicle 18, such as a sedan or a wagon. The fastener 14 of this embodiment functions to attach the bicycle carrier 10 to the roof 48 of the vehicle 18. The fastener 14 preferably includes clamps that attach to the rain gutters or roof racks of the vehicle 18, but may include any suitable device or method that attach the bicycle carrier 10 to the roof 48 of the vehicle 18.

In each of the preferred embodiments, but as best shown in FIG. 1, the bicycle carrier 10 also includes a guide 50 coupled to the frame 28. The guide 50 functions to substantially prevent rotation of the bicycle 16 about the post 12 during the transportation of the bicycle 16. The guide 50 preferably includes a pair of rods 52 and 54. Both rods 52 and 54 include a first end that is connected to the frame 28 and a second end that cooperatively creates a fork 56. The fork 56 functions to receive the top tube, or any other suitable portion, of the bicycle 16. Preferably, the rods 52 and 54 are made of a material that allows them to be flexed into different orientations to receive top tubes, or other suitable portions, of bicycles with different sizes and/or proportions. In a first alternative variation, the rods 52 and 54 may be integrally formed to each other, effectively becoming one rod. In other alternative embodiments, the bicycle carrier 1o may include any suitable device to substantially prevent rotation of the bicycle 16.

In each of the preferred embodiment, the bicycle carrier 10 also includes a hold-down system 58 coupled to the frame 28. The hold-down system 58 functions to substantially prevent lift of the bicycle 16 off the post 12 during the transportation of the bicycle 16. The hold-down system 58 preferably includes a flexible cable 60 that wraps around the top tube, or any other suitable portion, of the bicycle 16 and a cable cleat 62 that engages and holds the strap. The hold-down system 58 may alternatively include belts, ties, clamps, or any other suitable device or method that substantially prevents lift of the bicycle 16 off the post 12.

In each of the preferred embodiment, the bicycle carrier 10 also includes a handlebar stabilizing system 64. The handlebar stabilizing system 64 functions to prevent rotation of a handlebar of the bicycle 16 during the transportation of the bicycle 16. The handlebar stabilizing system 64 preferably includes an elastic cable 66 that wraps around the handlebar, or any other suitable portion of the bicycle 16, and a cable ball 68 that allows the elastic cable 66 to engage itself. The handlebar stabilizing system 64 may alternatively include belts, ties, clamps, or any other suitable device or method that substantially prevents rotation of a handlebar of the bicycle 16.

In the first preferred embodiments, the bicycle carrier 10 also includes a locking loop 70. The locking loop 70 functions to receive a lock, such as a chain or bar lock. The lock may be inserted through the top tube, or any other suitable portion of the bicycle 16, and the locking loop 70 to secure the bicycle 16 to the bicycle carrier 10, and hence to the vehicle 18. The locking loop 70 is preferably made of a metal material, but may alternatively be made of any suitable material.

In each of the preferred embodiments, as best shown in FIG. 1, the bicycle carrier 10 includes a second post 72. Preferably, the guide 50, hold-down system 58, and handlebar stabilizing system 64 are provided for each post 12. Preferably, the respective guide 50, hold-down system 58, and handlebar stabilizing system 64 are attached to the frame 28 on alternate sides to prevent interference. It will be understood by those in the art that, if appropriate structural adjustments are made to the frame 28 and the fastener 14, there may be more or less than two posts included in the bicycle carrier 10.

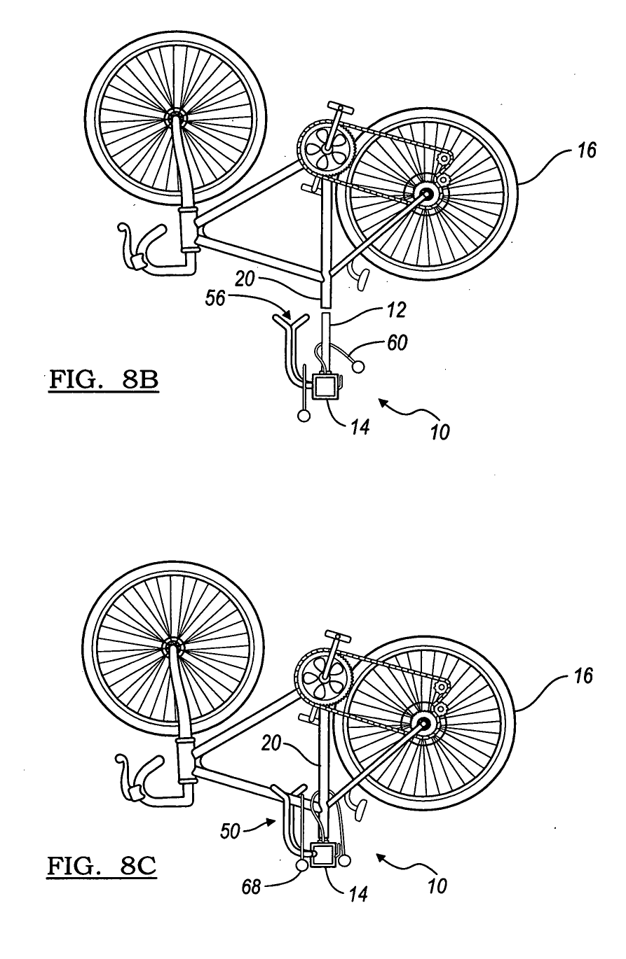

As shown in FIGS. 8A, 8B, and 8C, the method of the preferred embodiment includes the following steps: providing a bicycle carrier 1o having a post 12 and a fastener 14 and attaching the fastener 14 of the bicycle carrier 10 to the vehicle, removing a seat post 74 of the bicycle 16 and inverting the bicycle 16, and inserting the post 12 into the seat tube 20 of the bicycle 16. The method may also include other suitable steps, such as substantially preventing rotation of the bicycle 16 about the post 12, substantially preventing lift of the bicycle 16 off the post 12, and substantially preventing rotation of a handlebar of the bicycle 16.

The actual size and shape of a finished product of one of the preferred embodiments will depend, in part, on aesthetic considerations.

As a person skilled in the art will recognize from the previous detailed description and from the figures and claims, modifications and changes can be made to the preferred embodiments of the invention without departing from the scope of this invention defined in the following claims.

I claim:

1. A bicycle carrier to attach a bicycle with a seat tube to a vehicle, comprising:
a post adapted to be temporarily inserted into the seat tube; and
a fastener coupled to the post and adapted to attach to the vehicle.

2. The bicycle carrier of claim 1, wherein the post is cylindrically-shaped.

3. The bicycle carrier of claim 2, further comprising a protective layer attached to the post and adapted to reduce damage to the seat tube.

4. The bicycle carrier of claim 1, wherein the post includes a flexible portion adapted to conform to an inner diameter of the seat tube.

5. The bicycle carrier of claim 4, wherein the compressible portion includes several projections that extend in a radial direction from a central axis of the post.

6. The bicycle carrier of claim 1, wherein the fastener is adapted to attach to a hitch of the vehicle.

7. The bicycle carrier of claim 6, further comprising a frame connected to the post; wherein the fastener is connected to a first end of the frame and is adapted to mate with the hitch of the vehicle.

8. The bicycle carrier of claim 7, further comprising an additional receiver for a hitch connected to a second end of the frame.

9. The bicycle carrier of claim 7, further comprising a hinge mechanism connected to the frame between the post and the fastener and adapted to be operable between a locked and unlocked position.

10. The bicycle carrier of claim 1, wherein the fastener is adapted to attach to a bed of the vehicle.

11. The bicycle carrier of claim 10, further comprising a frame connected to the post and arranged to extend the substantial width of the bed of the vehicle; wherein the fastener is connected to the frame.

12. The bicycle carrier of claim 1, wherein the fastener is adapted to attach to a roof of the vehicle.

13. The bicycle carrier of claim 12, further comprising a frame connected to the post and arranged to extend the substantial width of the roof of the vehicle; wherein the fastener is connected to the frame.

14. The bicycle carrier of claim 1, further comprising a frame connected to the post.

15. The bicycle carrier of claim 14, wherein the fastener is integrally formed with the frame.

16. The bicycle carrier of claim 14, further comprising means for substantially preventing rotation of the bicycle about the post.

17. The bicycle carrier of claim 14, further comprising a guide coupled to the frame and adapted to substantially prevent rotation of the bicycle about the post.

18. The bicycle carrier of claim 17, wherein the guide includes a pair of rods, both rods having a first end connected to the frame and a second end that cooperatively creates a fork; wherein the rods may be flexed into a different orientation.

19. The bicycle carrier of claim 17, further comprising means for substantially preventing lift of the bicycle off the post.

20. The bicycle carrier of claim 17, further comprising a hold-down system coupled to the frame and adapted to substantially prevent lift of the bicycle off the post.

21. The bicycle carrier of claim 20, further comprising means for substantially preventing rotation of a handlebar of the bicycle.

22. The bicycle carrier of claim 20, further comprising a handlebar stabilizing system coupled to the frame and adapted to substantially prevent rotation of a handlebar of the bicycle.

23. The bicycle carrier of claim 14, further comprising a locking loop coupled to the frame and adapted to receive a lock.

24. The bicycle carrier of claim 14, further comprising a securing mechanism; wherein the frame includes a bore; wherein a first end of the post is adapted to be temporarily inserted into the seat tube and a second end of the post is adapted to be inserted through the bore of the frame; and wherein the securing mechanism is attached to the second end of the post thereby securing the post to the frame.

25. A method of temporarily attaching a bicycle with a seat tube to a vehicle, comprising the following steps:
a) providing a bicycle carrier having a post and a fastener;
b) attaching the fastener of the bicycle carrier to the vehicle;
c) removing a seat post of the bicycle;
d) inverting the bicycle; and
e) inserting the post into the seat tube of the bicycle.

26. The method of claim 25, further comprising the step of substantially preventing rotation of the bicycle about the post.

27. The method of claim 26, further comprising the step of substantially preventing lift of the bicycle off the post.

28. The method of claim 27, further comprising the step of substantially preventing rotation of a handlebar of the bicycle.
